(19) United States
(12) Patent Application Publication
(10) Pub. No.: US 2026/0366653 A1
(43) Pub. Date: Nov. 19, 2026

(54) THERMOPLASTIC PVC COMPOUND FOR MULTILAYER FUEL HOSE

(71) Applicant: CONTITECH USA, INC., Fairlawn, OH (US)

(72) Inventors: Naveed KHAN, Fairlawn, OH (US); Flint WILSON, Fairlawn, OH (US); Adam MCCRACKEN, Fairlawn, OH (US)

(21) Appl. No.: 19/515,127

(22) PCT Filed: Aug. 21, 2024
(86) PCT No.: PCT/US2024/043148

§ 371 Date: Feb. 27, 2026

Related U.S. Application Data
(60) Provisional application No. 63/579,310, filed on Aug. 29, 2023.

(51) Int. Cl. F16L 11/12; C08K 3/105; C08L 27/06; F02M 37/00; F16L 11/08

(52) U.S. Cl. CPC F16L 11/12; C08K 3/105; C08L 27/06; F02M 37/0017; F16L 11/08; C08L 2203/18

(57) ABSTRACT

A hose comprising an inner tube, a reinforcement layer disposed outwardly from the inner tube, and a cover layer disposed outwardly from the reinforcement layer. The inner tube comprises a thermoplastic material including polyvinyl chloride (PVC) and a non-leaching plasticizer comprising ethylene copolymer and butyl acrylate. The non-leaching plasticizer binds itself to the PVC polymer chain, making it more stable when exposed to chemicals such as fuel. This reduces the effect of deformation of the PVC material, thereby making it suitable for use as the internal tube of a fuel hose.

### RELATED APPLICATIONS

The present application claims the benefit of U.S. Provisional Application No. 63/579,310 filed Aug. 29, 2023, the entire disclosure of which is incorporated herein by reference.

### TECHNICAL FIELD

The present disclosure relates generally to a thermoplastic polyvinylchloride compound, particularly for hoses, and more particularly to multilayer reinforced hoses for high-performance applications, such as fuel transfer.

### BACKGROUND

Thermoplastic and rubber hoses are used in a variety of applications for transporting fluids such as liquids and gases. For example, one common application of a thermoplastic multilayer hose is as a fuel delivery hose (also referred to as a drop hose) that is used to transfer fuel from a fuel delivery vehicle to the storage tanks at a refueling facility. Generally, a drop hose should have sufficient flexibility to allow the hose to bend, chemical resistance to hydrocarbons in fuels, tensile strength to withstand pressure during fuel transfer, resistance to abrasion when dragged over rough surfaces, and light weight for ease of handling. Unlike traditional curb pump hoses, however, a drop hose is used only intermittently and therefore experiences much less exposure to fuel and with repeated cycles of drying between fueling events. As such, a conventional construction of a drop hose that satisfies performance requirements may include a thermoplastic polyurethane (TPU) inner tube, a reinforcement layer outward of the inner tube, and a thermoplastic cover layer outward of the reinforcement layer which may be made of polyvinylchloride (PVC).

### SUMMARY

At least one problem with conventional hoses such as drop hoses having a TPU inner tube is that they tend to be more expensive than other thermoplastic materials, such as PVC. This is particularly problematic for drop hoses or the like because they may have a relatively short life span compared to other fuel hose. Therefore, there is a need for a lower cost hose construction that can withstand the demands of such application.

Although PVC is conventionally much less expensive than TPU, these PVC materials generally are not used for fuel applications because they have limited resistance to certain organic solvents, including gasoline and other hydrocarbons found in fuels. In particular, when conventional PVC comes into contact with these hydrocarbons, the plasticizers in the material can leach, which causes the material to deform (e.g., shrink or swell). This deformation leads to a decrease in material performance, such as reduced strength, increased permeability, changes in dimensional stability of the material, and the material becoming hard or soft. Accordingly, a need remains to provide an affordable material such as PVC that is suitable for use as the inner tube of the hose.

At least one aspect of the present disclosure solves one or more problems associated with conventional materials used for the inner tube of a hose, such as drop hoses used in fuel transfer applications. More particularly, an aspect of the present disclosure provides a unique PVC compound that uses a non-leaching plasticizer to reduce dimensional changes when exposed to fuel and/or provides other material properties that make the PVC compound suitable for use as the inner tube of a hose, particularly for use as the inner tube of a fuel drop hose that has intermittent exposure to fuel.

According to an aspect, an exemplary hose includes: an inner tube forming an internal passage, a reinforcement layer disposed outwardly from the inner tube, and a cover layer disposed outwardly from the reinforcement layer, wherein the inner tube comprises a thermoplastic material including polyvinyl chloride (PVC) and a non-leaching plasticizer comprising ethylene copolymer and butyl acrylate.

Such a non-leaching plasticizer binds itself to the PVC polymer chain, making it more stable when exposed to chemicals such as fuel. This reduces the effect of deformation of the PVC material, thereby making it suitable for use as the internal tube of the hose for certain applications.

According to another aspect, an exemplary thermoplastic material includes polyvinylchloride in a total amount from 80 phr to 100 phr; a non-leaching plasticizer in a total amount from 20 phr to 50 phr, the non-leaching plasticizer having ethylene copolymer and butyl acrylate; at least one additional plasticizer in a total amount from 20 phr to 60 phr; and at least one stabilizer in a total amount from 2 phr to 25 phr.

According to another aspect, an exemplary thermoplastic PVC compound includes a non-leaching plasticizer including ethylene copolymer and butyl acrylate, and has material properties suitable for use in a hose or the like.

The following description and the annexed drawings set forth certain illustrative embodiments according to the present disclosure. These embodiments are indicative, however, of but a few of the various ways in which the principles of the invention may be employed. Other objects, advantages and novel features according to aspects of the present disclosure will become apparent from the following detailed description when considered in conjunction with the drawings.

### BRIEF DESCRIPTION OF THE DRAWINGS

The annexed drawings, which are not necessarily to scale, show various aspects according to the present disclosure.

FIG. 1 shows an exemplary embodiment of a hose according to the present disclosure.

FIG. 2 shows another exemplary embodiment of a hose according to the present disclosure.

FIG. 3 shows another exemplary embodiment of a hose according to the present disclosure.

FIG. 4 shows another exemplary embodiment of a hose according to the present disclosure.

FIG. 5 shows another exemplary embodiment of a hose according to the present disclosure.

FIG. 6 shows another exemplary embodiment of a hose according to the present disclosure.

FIGS. 7 and 8 show another exemplary embodiment of a hose according to the present disclosure.

### DETAILED DESCRIPTION

The principles and aspects according to the present disclosure have particular application to hoses, in particular fuel drop hoses, and thus will be described herein mainly in this context. It is understood, however, that the principles and aspects of the present disclosure may be applicable to other types of hoses for other applications, or to other articles in general, when desirable to provide one or more advantages of the material(s) and/or construction(s) described herein.

Conventional polyvinylchloride (PVC) materials typically contain processing aids, plasticizers, stabilizers, and possibly other additives. Because of the susceptibility of conventional plasticizers to leach from the PVC material when exposed to chemicals such as hydrocarbons in fuel, these conventional PVC materials are typically not used as the inner tube material of a hose. Rather, more expensive compounds like thermoplastic polyurethane (TPU), nitrile rubbers, or fluorelastomers are used to form the hose inner tube.

Aspect(s) of the present disclosure provide a unique thermoplastic PVC compound as described herein which reduces leaching of plasticizer when exposed to chemicals such as fuel, thereby reducing dimensional changes (e.g., swell). The unique PVC compound also may have other material properties making it particularly suitable for use in articles such as hose. As described in further detail below, exemplary embodiment(s) of the present disclosure include a hose having at least an inner tube, in which the inner tube includes the exemplary thermoplastic PVC compound. Embodiment(s) according to the present disclosure also include multilayer hose constructions having an inner tube, a reinforcement layer disposed outwardly from the inner tube, and a cover layer disposed outwardly from the reinforcement layer.

The inner tube of the hose is the innermost layer that forms the internal fluid passage, or lumen, of the hose and comes into contact with the fluid being conveyed. This tubular inner layer may be referred to simply as the “tube,” or as the “core.” The inner tube contains and conveys the service fluid and therefore is chemically resistant to the fluid. The inner tube also may form a permeation barrier that is resistant to permeation of the fluid conveyed through the inner tube. The inner tube lends strength to the hose for increasing burst pressure and may operate in conjunction with other layer(s) of the hose to provide a relatively high burst pressure. To maintain overall flexibility of the hose, the material of the inner tube may be relatively flexible with a relatively low initial modulus.

The inner tube includes the exemplary thermoplastic PVC compound with non-leaching plasticizer for improving at least the chemical resistance and resistance to deformation (e.g., swell) of the material. Such a material may be particularly useful for applications with intermittent exposure to fuel, for example applications in which the material is exposed to fuel for less than half of its ordinary service life, and/or which experiences intermittent drying events between fuel exposure, both of which are conditions experienced by a typical fuel drop hose. Exemplary types of fuel to which the PVC compound may be particularly chemically resistant include conventional petroleum-based fuel, such as gasoline or diesel; bio-based fuel, such as well as bio-diesel (e.g., up to B20) or bio-gas (e.g., up to CE10 meeting ASTM B6751 criteria); or blends thereof. As described in further detail below, the PVC compound also may contain various additional additives in suitable amounts, including, but not limited to, additional plasticizer(s), stabilizer(s), processing aid(s), or the like. Further additional additives may be included, or may be specifically excluded, including reinforcing agents, fillers, or the like.

The matrix of the composition includes PVC polymer which serves as the base of the composition. The composition also may contain other polymer(s) that are blended with the base elastomer(s) to also form part of the matrix of the composition. The total polymer content forming the base composition (which may include mixtures of base polymers) is set at 100 phr. The additives in the composition are compounded relative to the total base polymer content of the composition, and as such may be represented in parts per hundred (phr), which means parts by weight per 100 parts by weight of the base polymer(s).

The thermoplastic PVC compound may include one or more polyvinylchloride homopolymer resins in a total amount from about 80 parts per hundred (phr) to about 100 phr, more particularly from about 90 phr to about 100 phr, such as about 100 phr. The PVC resins, or blends thereof, may have any suitable molecular weight or intrinsic viscosity for the particular application, including the final material properties for the application or processing properties for making the product of the application. For example, the PVC resin, or blends thereof, may have an intrinsic viscosity as measured by the Fikentscher K value in a range from about K65 to about K80, more particularly in a range from about K72 to about K78, such as about K65, K68, K72, K73, K74, K75, K76, K77, K78, or K80. In the case of blends, the K-value of each component resin may be taken to calculate the overall (average) K-value. The K-value is a unitless empirical measure closely related to intrinsic viscosity, often defined in slightly different ways in different industries to express viscosity-based estimate of statistical molecular mass and average degree of polymerization of polymeric material used particularly for PVC. A commonly used K value in Europe is the Fikentscher K value (referenced in DIN EN ISO 1628-1) obtained by dilute solution viscometry and solving Fikentscher equation. The K-value generally correlates to the molecular weight of the PVC resin, such that higher K-values indicate higher molecular weight PVC (and thus greater strength), while lower K-values represent lower molecular weight PVC.

The non-leaching plasticizer used in the PVC compound may impact processability and material performance, and therefore in exemplary embodiments the PVC compound includes a blend of at least one first PVC homopolymer resin having a lower K-value (and thus lower molecular weight) than at least a second PVC homopolymer resin. This can improve mechanical properties of the compound while still providing the effects of the non-leaching plasticizer. For example, the first PVC resin may have a K-value in a range from about K65 to about K75 (e.g., K65, K68, K69, K70, K71, K72, K73, K74, K75), and the second PVC resin may have a K-value in a range from about K76 to about K85 (e.g., K76, K77, K78, K79, K80, K81, K82, K83, K85). The blended K-value of the first and second PVC resins may be in the range(s) described above.

In exemplary embodiments, the first lower K-value PVC resin may be present in the PVC compound in a range from about 20 phr to about 60 phr, more particularly in a range from about 40 phr to about 55 phr, such as about 40, 45, 50, or 55 phr. The second higher K-value PVC resin may be present in the PVC compound in a range from about 20 phr to about 60 phr, more particularly in a range from about 40 phr to about 55 phr, such as about 40, 45, 50, or 55 phr. The total PVC resin content may be in a range from about 80 phr to 100 phr, or subranges thereof, as described above. Thus, a ratio of the low K-value PVC resin content (phr) to total PVC resin content (phr) may be in a range from 20:50 to 60:40 (e.g., 20:80, 20:80, 20:100, 40:80, 40:100, 40:100, 60:80, 60:100, 60:100, etc.); and the ratio of the high K-value PVC resin to total PVC resin content may be the same or balance thereof.

The non-leaching plasticizer in the PVC compound may be present in any suitable amount, and may include one or more types of such non-leaching plasticizer that includes ethylene copolymer and butyl acrylate in any suitable amount. For example, the total amount of the non-leaching plasticizer present in the PVC compound may be in a range from about 20 phr to about 60 phr, more particularly from about 20 phr to about 50 phr, even more particularly from about 20 phr to about 40 phr, such as about 20, 25, 30, 35, 40, 45, 50, 55, or 60 phr (including all values and ranges between the stated values).

The non-leaching plasticizer may be miscible in the PVC blend and exhibit good compatibility with the PVC matrix. Generally, the non-leaching plasticizer is configured to bind to the PVC polymer backbone chain to enhance its stability and non-leaching effect. The non-leaching plasticizer may include an additional functional group to form a terpolymer and improve coordination bonding with the PVC backbone.

The proportion of butyl acrylate in the non-leaching plasticizer may be from 5 to 50 weight percent (such as 10 to 40 weight percent, or 30 weight percent), the amount of additional functional group when present may be from 3 to 30 weight percent (such as 3 to 10 weight percent), and the remainder of the plasticizer compound is ethylene copolymer (e.g., 40 to 80 weight percent, such as 50 to 65 weight percent). For example, the non-leaching plasticizer may be a terpolymer having 40% ethylene copolymer, 40% butyl acrylate, and 20% of a functional unit that improves coordination bonding. These values can be used to determine the proportional amounts in the PVC compound. For example, taking into account the total amount of the non-leaching plasticizer present in the PVC compound from about 20 phr to about 60 phr, the amount of butyl acrylate present in the PVC compound may be from about 1 phr to 30 phr, more particularly from about 5 phr to about 15 phr (such as 1, 3, 5, 8, 10, 15, 20, 25 or 30 phr); and the amount of ethylene copolymer may be present in the PVC compound in a range from about 8 phr to about 55 phr, more particularly from about 10 phr to about 30 phr (such as 8, 10, 15, 20, 25, 30, 35, 40, 45, 48, 50, or 55 phr). The amount of additional functionalized unit when present also may be calculated similarly.

The exemplary PVC compound may include additional plasticizer(s). For example, the additional plasticizer(s) may be present in the PVC compound in a total amount from about 20 phr to about 90 phr, more particularly from about 30 phr to about 50 phr, such as about 20, 25, 30, 35, 40, 45, 50, 55, 60, 65, 70, 75, 80, 85 or 90 phr. Any suitable plasticizer or combination of plasticizers may be used in the PVC compound, and particularly may include stable-type plasticizer(s) within the PVC compound to further reduce leaching of the additional plasticizer(s). In exemplary embodiment(s), the additional plasticizer(s) may include a carboxylic acid ester, such as a trimellitate plasticizer, for example trioctyl trimellitate (TOTM). Such a TOTM plasticizer has relatively low volatility, such that it does not easily evaporate or leach at normal operating temperatures. The TOTM plasticizer also provides good resistance at higher temperatures.

The additional plasticizer(s) may work in conjunction with the non-leaching plasticizer to improve the anti-deformation properties of the PVC compound. The additional plasticizer(s) also may help processability and/or reduce cost in conjunction with the use of the non-leaching plasticizer. In exemplary embodiments, the non-leaching plasticizer (described above) and one additional plasticizer (e.g., TOTM) may constitute the total plasticizer content in the PVC compound. The total amount of plasticizer in the PVC compound may be in a range from about 40 phr to about 110 phr, more particularly about 50 phr to about 70 phr, such as about 40, 45, 50, 55, 60, 65, 70, 75, 80, 85, 90, 95, 100, 105, or 110 phr total plasticizer content in the PVC compound. Thus, in view of the non-leaching plasticizer and additional plasticizer(s) amounts described above, a ratio of the non-leaching plasticizer content (phr) to the total plasticizer content (phr) may be in a range from about 20:110 to about 60:100, more particularly from about 20:70 to about 40:80, including all ranges and subranges therebetween, with the additional plasticizer(s) (e.g., TOTM) being the balance. So, for example, the proportion of the non-leaching plasticizer to the total plasticizer content may be in a range from 25% to 50%, more particularly 25% to 40%, including all values and ranges between the stated values.

Because PVC is thermally sensitive, the PVC compound may include one or more stabilizers. The total amount of stabilizer(s) may be present in the PVC compound in a total amount from about 5 phr to about 40 phr, more particularly from about 5 phr to about 15 phr, such as about 5, 10, 15, 20, or 25 phr. Any suitable stabilizer or combination of stabilizers may be used in the PVC compound. For example, suitable stabilizers may include a carboxylate, such as barium zinc, and/or an epoxidized natural oil, such as epoxidized soybean oil. In exemplary embodiment(s), barium zinc stabilizer may be used in the PVC compound in a total amount from about 1.5 phr to about 15 phr, more particularly from about 1.5 phr to about 5 phr, more particularly about 2.5 phr. An additional stabilizer of epoxidized soybean oil also may be used in a range from about 3 phr to about 40 phr, more particularly from about 3 phr to about 10 phr, such as about 3, 4, 5, 7, 10, 15, or 20 phr.

Additional additives, such as processing aids also may be included in the PVC compound. For example, stearic acid may be used to improve processability of the PVC compound by enhancing flowability of the material and aid in the dispersion of other compounding ingredients. In exemplary embodiments, the stearic acid may be provided in the PVC compound in a total amount from about 0.1 phr to about 0.5 phr, such as about 0.3 phr.

Further non-limiting examples of thermoplastic PVC compositions for the inner tube are described in further detail below in connection with Tables 1-5.

Turning now to the reinforcement layer of the hose, this layer is located between the inner tube and the cover layer. The reinforcement layer provides additional strength to the hose, typically by applying strands of reinforcement around the inner tube. The strands may include monofilaments, multi-filaments, tows, yarns, or the like. The layer(s) of strands may have any suitable configuration or combination of configurations, and the strands may be made of any suitable material or combination of materials for reinforcing the hose.

The reinforcement material of the strands may include, but is not limited to, metal, synthetic or natural material. For example, the reinforcement strands may be steel wire (such as stainless-steel wire, plated-steel wire, plain steel wire, or the like). Alternatively or additionally, the reinforcement strands may be filaments, such as fibers, which may be in the form of yarns (or fabrics woven from yarns). Such materials may include nylon, vinylon, aramid, rayon, polyester (such as polyethylene terephthalate or polyethylene naphthalate), polyvinyl acetate, polyvinyl alcohol (PVA), poly p-phenylene-2,6-benzobisoxazole (PBO), polypropylene, polyamide, carbon fiber, ceramic fiber (e.g., silicon carbide), cotton, hemp, or the like.

In some embodiments, the strands of reinforcement material are arranged in a braided, spiral, knitted, or wrapped reinforcement construction. The hose may include one or more of these layers of reinforcement, and each layer may have a different orientation of strand arrangement. For example, where two or more layers of spiral reinforcement may be used, a first layer may be spiral wound in a first winding direction, and a second layer spiral wound in a second winding direction opposite the first winding direction. Generally, a braided or woven reinforcement may include between one to three layers of reinforcement, and spiral reinforcement may include four to six layers, although each may change depending on the desired properties for the particular application. Between each layer of reinforcement strands, an interlayer or friction layer may be provided to create a bonding effect and to reduce friction wear between strands.

Turning to the cover layer, this layer is located outwardly of the reinforcement layer and serves to protect the inner tube and/or the reinforcement layer from the environment of the hose when deployed for use in the field. The cover layer may have any suitable configuration and be made of any suitable material. Several factors may be used to determine the construction and/or materials selection for the cover layer, including but not limited to abrasion resistance, chemical resistance, economy, aesthetics, or the like.

The cover layer material may include, but is not limited to, ethylene propylene rubber (EPR), ethylene-propylene-diene rubber (EPDM), EPDM/EPR, acrylonitrile butadiene rubber (NBR), hydrogenated NBR, carboxylated NBR, polychloroprene rubber, fluoroelastomer rubber, epichlorohydrin (ECO) rubber, nitrile rubber, carboxylated nitrile rubber, chlorinated polyethylene (CPE), chlorosulfonated polyethylene (CSM) rubber, styrene-butadiene rubber (SBR), polyvinyl chloride (PVC), nitrile/PVC rubber, styrene/ethylene-butylene/styrene-based (SEBS), thermoplastic elastomers (TPE), thermoplastic vulcanizates (TPV), thermoplastic polyurethanes (TPU), polyolefin elastomers (POE), or any suitable mixtures thereof. The cover layer compound may further include various additives in conventional or suitable amounts including, but not limited to, pigments and/or dyes to provide a color, retardants, antioxidants, vulcanizing agents, cure accelerators or other processing aids, reinforcing agents and fillers, such as carbon black, silica, other mineral fillers (e.g., calcium carbonate, talc, etc.), or the like. As an example, reinforcing fillers may be provided in a range from about 20 phr to about 700 phr, including for example carbon black from about 200 phr to about 400 phr; and plasticizers such as oils may be provided in a range from about 10 phr to about 200 phr.

Certain embodiments of the disclosure will hereafter be described with reference to the accompanying drawings, in which like reference numerals denote like elements. It should be understood, however, that the accompanying figures illustrate the various implementations described herein and are not meant to limit the scope of various technologies described herein. In addition, it is understood that various aspects and features of these embodiments may be substituted for one another or used in conjunction with one another where applicable.

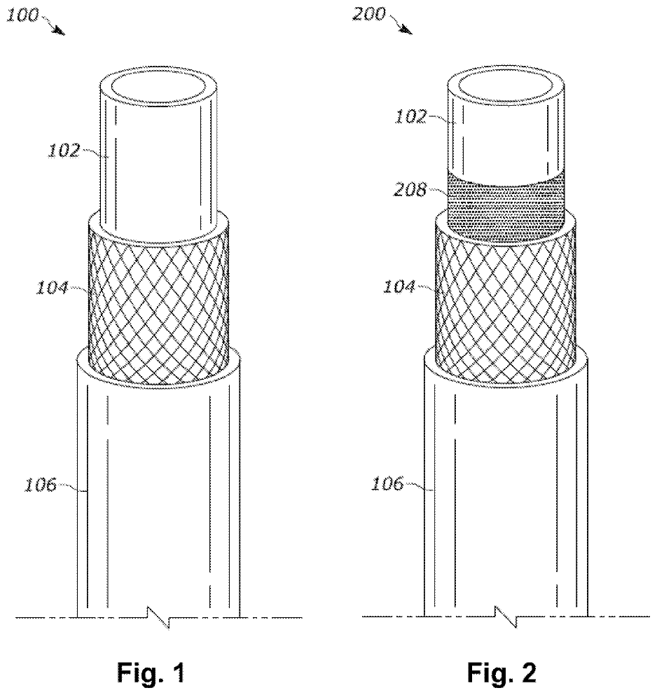

FIGS. 1-8 illustrate exemplary embodiments of hoses according to the present disclosure. As shown, the exemplary hoses generally include at least an inner tube 102, a reinforcing layer 104, and an outer cover layer 106. These layers 102, 104 and 106 may be formed with any of the material(s) and/or construction(s) in accordance with the description above.

In the various embodiments, the inner diameter, outer diameter, and thickness of the differing layers of the hose may be as desired for achieving the characteristics of the hose for the particular application(s). For example, exemplary hoses may have an inside diameter which is within the range of about 0.5 inch (12.7 mm) to about 4 inches (about 100 mm) and an outside diameter of about 1 inch (25.4 mm) to about 6 inches (about 150 mm). The overall wall thickness of the hose including all layers may be within a range from about 0.10 inch (2.5 mm) to about 0.4 inch (10 mm) or more. The wall thickness of the inner tube 102 may be in a range from about 0.02 inch (0.5 mm) to about 0.16 inch (4 mm), more particularly from about 1 mm to about 3 mm. The wall thickness of the outer tube 106 may be in a range from about 0.04 inch (1 mm) to about 0.12 inch (3 mm).

Referring initially to FIG. 1, an exemplary construction of a hose 100 is shown, including inner tube 102, reinforcement layer 104, and cover layer 106. Generally, to provide advantages of the exemplary thermoplastic PVC compound, an entirety of the inner tube 102 may be formed by the PVC compound. As an example, the hose 100 may be produced by forming the inner tube 102 according to known extrusion processes, optionally with a bonding layer on its outer surface, and then applying the reinforcement layer 104 with the arrangements described above. The outer cover layer 106 then covers the reinforcement layer 104, such as by extrusion, winding or the like, so as to bond the layers of the hose integrally. The applicable hose materials may then be cured.

FIG. 2 illustrates another exemplary embodiment of a hose 200 including an inner tube 102, reinforcing layer 104, and outer cover layer 106, similar to hose 100 described above, and further including intermediate layer 208, which may be a ply reinforcement layer, or bonding layer (tie layer), or backing layer, or barrier layer, or the like. As shown, the intermediate layer 208 is disposed between the inner tube 102 and reinforcing layer 104. When used as a ply reinforcement layer, for example, the layer 208 is not particularly limited, but may be produced from any suitable natural or synthetic material such as by vinylon fiber, rayon fiber, polyester fiber, nylon fiber, natural fiber, or aramid fiber, etc. in a ply configuration. When used as a bonding layer (also referred to as a tie layer), the intermediate layer 208 may be formed from any suitable material(s), such as those that are adhesion bond compatible with its adjacent layers (e.g., reinforcement layer 104 and inner tube 102). When used as a barrier layer, the layer 208 is not particularly limited, but may be produced from polyamide, thermoplastic fluoropolymer, such as Polyvinylidene fluoride (PVDF), Tetrafluoroethylene-Hexafluoropropylene-Vinylidene Fluoride (THV), or the like. As a barrier layer, the layer 208 may be a permeation inhibiting layer which may be a relatively thin veneer or layer, such as in a range from about 0.002 inch (0.05 mm) to about 0.01 inch (0.254 mm) thick. The thin barrier layer may assist with permeation resistance while still permitting sufficient flexibility of the hose. In exemplary embodiments, the inner tube 104 may provide sufficient permeation resistance such that the hose is devoid of such a barrier layer 208.

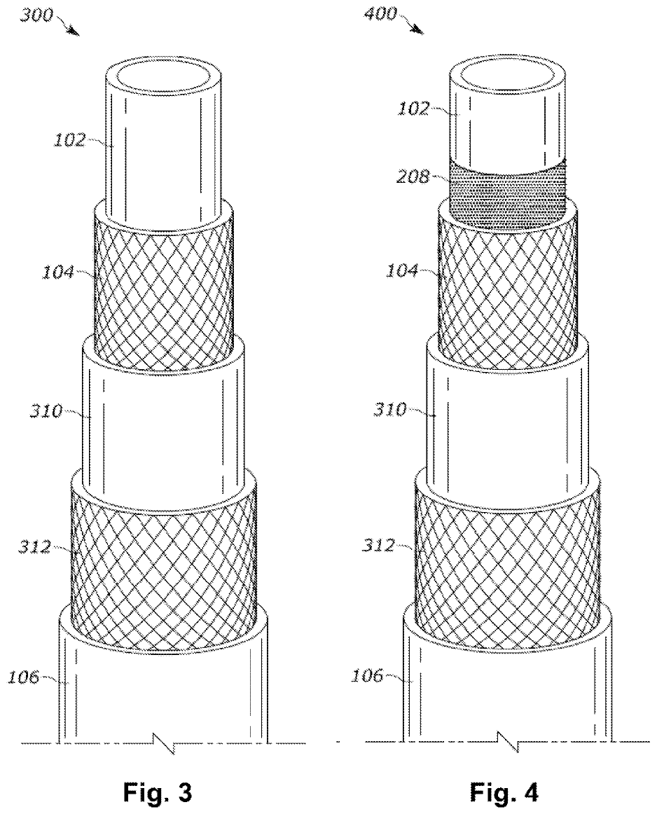

Turning to FIG. 3, another exemplary hose 300 is illustrated, which includes inner tube 102, reinforcing layer 104, filler layer or friction layer 310, second reinforcing layer 312, and outer cover layer 106. The second reinforcing layer 312, is not particularly limited, but may be produced from any suitable material(s) or construction(s) as described above in connection with reinforcement layer 104. The friction layer 310 also is not particularly limited, and is configured to reduce friction wear between the strands of the reinforcement layers 104 and 312. The friction layer 312 may be formed from any suitable material, such as curable rubber-based composition(s), for example containing rubber such as EPR, EPDM, acrylonitrile butadiene rubber (NBR), hydrogenated NBR, carboxylated NBR, polychloroprene, fluoroelastomer, epichlorohydrin, nitrile, carboxylated nitrile rubber, CPE, CSM, styrene-butadiene rubber (SBR), NBR/PVC blends, or any blends thereof. A rubber-based compound of the friction layer 312 also may contain various additives in conventional or suitable amounts including, but not limited to, adhesion promoters, retardants, antioxidants, vulcanizing agents, cure accelerators or other processing aids, reinforcing agents and fillers, such as carbon black, silica, other mineral fillers (e.g., calcium carbonate, talc, etc.), or the like. As an example, reinforcing fillers may be provided in a range from about 20 phr to about 700 phr, including for example carbon black from about 200 phr to about 400 phr; and plasticizers such as oils may be provided in a range from about 10 phr to about 200 phr. The friction layer 312 may be from about 0.020 inches (0.5 mm) to about 0.120 inches (3 mm) thick.

FIG. 4 shows another exemplary hose 400 including an inner tube 102, reinforcing layer 104, friction layer 310, second reinforcing layer 312, and outer cover 106. The hose 400 further includes an optional intermediate layer 208 disposed between inner tube 102 and reinforcing layer 104. The intermediate layer 208 may be as described above in connection with FIG. 2, including for example a ply reinforcement layer which may be made from any suitable materials and in any suitable construction.

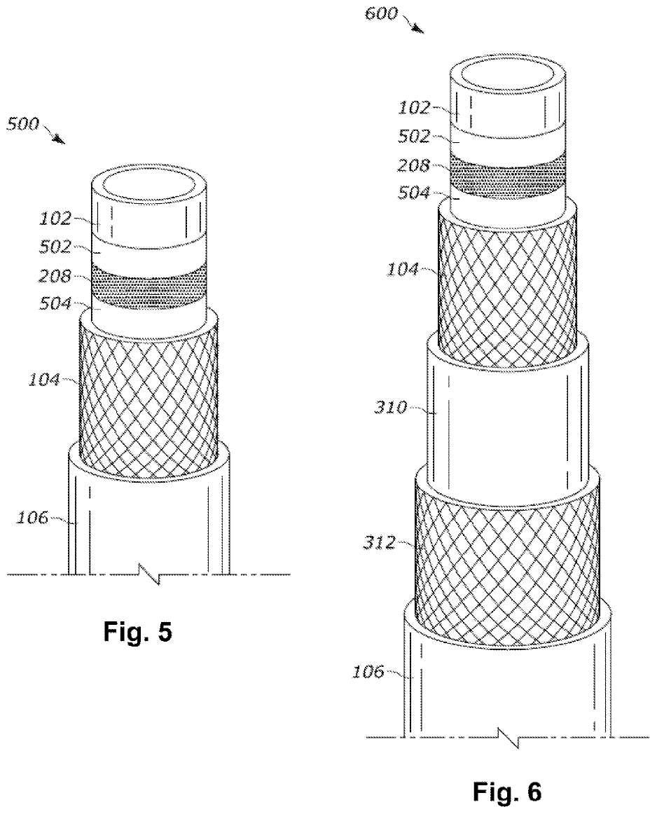

Referring to FIG. 5, yet another exemplary hose 500 is shown, including an inner tube 102, reinforcing layer 104, outer cover 106, and intermediate layer 208, which may be a ply reinforcement layer, or bonding layer, or backing layer, or barrier layer, etc. as described above in connection with hose 200. The hose 500 further includes a filler layer or friction layer 502 disposed between inner tube 102 and intermediate layer 208. Also, disposed between intermediate layer 208 and reinforcing layer 104 is filler or friction layer 504. The filler or friction layers 502, 504 may be formed from the materials and/or have the structure described above for friction layer 310 in FIG. 3. The friction layer 502 and friction layer 504 may have the same or different material(s), and may have the same or different construction. In embodiments without an intermediate layer 208, only one filler or friction layer 502 may be employed between inner tube 102 and reinforcement layer 104. As such, the friction layer 502 may be in direct contact with the inner tube 102 and/or the reinforcement layer 104.

FIG. 6 shows another exemplary hose 600, which is similar to hose 500, and further includes friction layer 310 and second reinforcing layer 312 disposed between reinforcing layer 104 and outer cover 106. The friction layer 312 and second reinforcing layer 312 may be as described above in connection with FIG. 3.

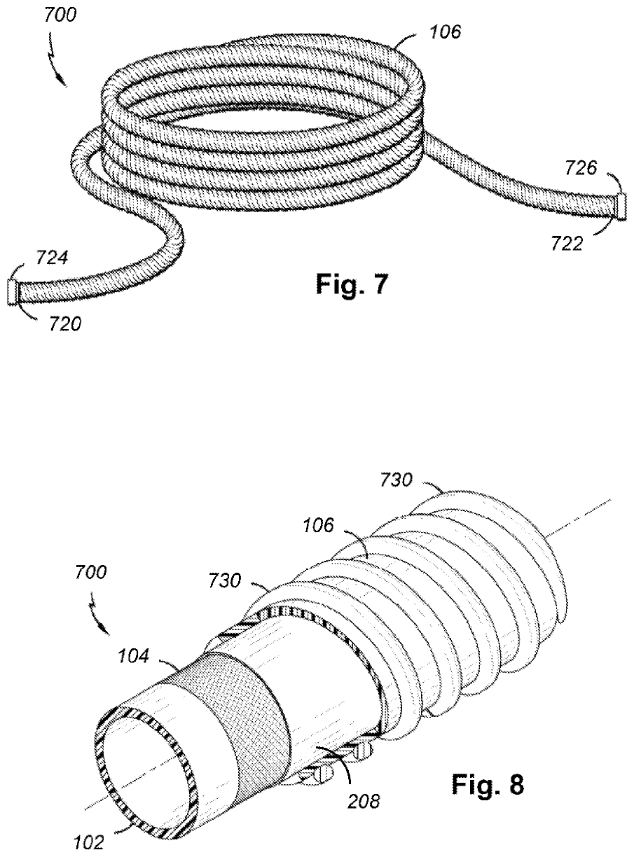

Turning to FIGS. 7 and 8, an exemplary drop hose 700 is shown, which includes inner tube 102, reinforcement layer 104, intermediate layer 208, and outer cover layer 106. The inner tube 102 is formed from the exemplary PVC compound having the non-leaching plasticizer as described herein. In a drop hose construction, the reinforcement layer may include strands of polyethylene fibers or other suitable material(s), which may be spiral wound biaxially around the inner tube 102. The intermediate layer 208 in this construction may be formed as a tie layer formed from suitable material(s), such as thermoplastic polyurethane (TPU) and which may adhesively tie together the adjacent reinforcement layer 104 and outer cover layer 106. The outer cover layer 106 may be formed from thermoplastic PVC or other suitable material, or combination of materials, including that of rigid PVC as a helix layer, for example.

As shown in FIG. 8, the outer cover layer 106 may have at least one helically wound reinforcing strip 730 which is at least partially embedded within the outer cover layer 106; or co-formed in an alternating pattern with the cover layer 106. Each of the reinforcement strip(s) 730 may include a plurality of continuous coils or turns, that are wound with a spiral or helical winding pattern having a pitch such that adjacent turns are spaced apart from each other in the longitudinal direction. The strip(s) 730 may be formed from a material having a higher modulus than the material of the cover layer 106 to impart greater rigidity and an anti-kinking nature to the hose 700. For example, the strip(s) 730 may be formed from a PVC material (or other suitable material) having a greater molecular weight and modulus than the molecular weight and modulus of the PVC material of the cover layer 106. The strip(s) 730 may be manufactured using known extrusion or other process(es) applied to the cover layer 106; or the strips 730 may be co-extruded in an alternating pattern with the material of the cover layer 106 to form an integral cover layer. In this manner, the outer cover layer 106 of hose 700 may include spiral or helically wound strips 730, or segments 730, of higher modulus material that are axially spaced apart, with regions of lower modulus material at least between strips or segments. In some embodiments, another layer (not shown) may be applied over the strips 730 and layer 106 to form the overall cover layer.

As shown in FIG. 7, the hose 700 includes opposite ends 720, 722 that may be terminated by fluid connectors 724, 726, respectively, for coupling the hose 700 to a fluid source (e.g., fuel tanker) and a fluid destination (e.g., storage tank). In a drop hose application, the fluid connectors 724, 726 may be American Petroleum Institute (API) style couplers. Other suitable connecters that may be used include, but is not limited to, camlock couplers, flange connectors, quick disconnect-type couplers, or the like.

Generally, such a drop hose 700 provides sufficient flexibility to allow the hose to bend, chemical resistance to hydrocarbons in fuels, tensile strength to withstand pressure during fuel transfer, resistance to abrasion when dragged over rough surfaces, and light weight for ease of handling. Typically, during the service life of such a drop hose 700, the exposure to fuel within the lumen is intermittent, for example for a couple of hours per day. Between fueling intervals, the PVC compound of the inner tube will dry, and then will be re-exposed to fuel over and over. This contrasts with a conventional curb pump hose which typically has greater than 50% of its time exposed to fuel.

Examples were prepared and tested for the purpose of further illustrating the nature of some of the embodiments and aspects of the disclosure and are not intended as a limitation on the scope thereof. These examples are shown in Tables 1-5.

Turning first to Table 1, formulations are provided for different test samples, including an exemplary PVC composition according to the present disclosure having the non-leaching plasticizer in a total amount of 20 phr (“Ex. 1”), and a comparative example of a similar PVC composition without the non-leaching plasticizer (“CE1”). All values in Table 1 are in parts per hundred (phr).

TABLE 1

| Ingredient | Ex. 1 | CE1 |
|---|---|---|
| PVC Resin (K73) | 50 | — |
| PVC Resin (K80) | 50 | 100 |
| Trimelliate (TOTM) Plasticizer | 40 | 60 |
| Non-Leaching Plasticizer | 20 | 0 |
| (incl: Ethylene co-polymer + butyl | | |
| acrylate) | | |
| Barium Zinc Stabilizer | 2.5 | 2.5 |
| Epoxidized Soybean Oil | 5 | 4 |
| Stearic Acid | 0.3 | 0.3 |
| Running Total (phr) | 167.8 | 166.8 |

Table 2 shows test data comparing the samples from Table 1, in addition to test samples from a commercially available hose, listed as CE2. The CE2 hose material is understood to be based on conventional thermoplastic polyurethane (TPU) inner tube material. The testing in Table 2 involved: 1) soaking each test sample in its own container with a particular fresh fuel for one week; 2) removing and drying each sample in ambient air for 24 hours; 3) recording the volume change; 4) refilling each container with fresh fuel of the same type, and re-soaking the same sample for another week; and 5) repeating the process for four consecutive weeks. The data in Table 2 shows testing with two different types of fuels, including B20 (80% diesel and 20% biodiesel) and CE10 (90% Fuel C and 10% ethanol, in which Fuel C constitutes 50% isooctane and 50% toluene). In the test data, a negative volume change signifies shrinkage and a positive volume change signifies swell.

TABLE 2

| | Ex. 1 | CE1 | CE2 |
|---|---|---|---|
| CE-10 Fuel | | | |
| Week 1 | 0% | −17% | −3% |
| Week 2 | −1% | −20% | −3% |
| Week 3 | 0% | −21% | −5% |
| Week 4 | −3% | −23% | −4% |
| B-20 Fuel | | | |
| Week 1 | +8% | +8% | −3% |
| Week 2 | +11% | +7% | −5% |
| Week 3 | +11% | +5% | −7% |
| Week 4 | +9% | +3% | −8% |

As shown in Table 2, the exemplary compound of Ex. 1 performs similarly to the commercially available TPU compound of CE2 in both the B-20 and CE-10 fuels. As noted above, however, PVC compounds are generally less expensive than TPU materials, and therefore the exemplary compound Ex. 1 provides at least this benefit over the TPU compound. In addition, the exemplary compound Ex. 1 with the non-leaching plasticizer shows a significant improvement in dimensional change when soaked in the CE-10 fuel compared to the other PVC sample CE1 without the non-leaching plasticizer. A specification for this test methodology when soaked in CE-10 fuel indicates that-10% to +25% volume change is acceptable; and a specification when soaked in B-20 fuel indicates that-10% to +40% volume change is acceptable. Therefore, the exemplary compound Ex. 1 satisfies these requirements.

Tables 3-5 illustrate additional test data in which the exemplary formulation was varied. Table 3 illustrates varying the amount of non-leaching plasticizer in the exemplary formula to determine its effect, and these test samples are listed below as Ex. A through Ex. D. Table 4 illustrates the inclusion of nitrile rubber at varying amounts in addition to non-leaching plasticizer, and these samples are listed as Ex. E through Ex. H. Again, all values are listed in parts per hundred (phr) in Tables 3 and 4. Table 5 lists test data for compounds Ex. A through Ex. H, including standard tensile testing according to ASTM D412 and Shore A hardness testing according to ASTM D2240. Table 5 also lists volume change data as a result of soaking the samples for one week in CE10 fuel.

TABLE 3

| Ingredient | Ex. A | Ex. B | Ex. C | Ex. D |
|---|---|---|---|---|
| PVC Resin (K80) | 100 | 100 | 100 | 100 |
| Trimelliate (TOTM) Plasticizer | 45 | 45 | 45 | 45 |
| Non-Leaching Plasticizer | 20 | 30 | 40 | 50 |
| (incl: Ethylene co-polymer + | | | | |
| butyl acrylate) | | | | |
| Barium Zinc Stabilizer | 2.5 | 2.5 | 2.5 | 2.5 |
| Epoxidized soybean oil | 4 | 4 | 4 | 4 |
| Running Total (phr) | 171.5 | 181.5 | 191.5 | 201.5 |

TABLE 4

| Ingredient | Ex. E | Ex. F | Ex. G | Ex. H |
|---|---|---|---|---|
| PVC Resin (K80) | 100 | 100 | 100 | 100 |
| Trimelliate (TOTM) Plasticizer | 45 | 45 | 45 | 45 |
| Non-Leaching Plasticizer | 20 | 20 | 20 | 20 |
| (incl: Ethylene co-polymer + | | | | |
| butyl acrylate) | | | | |
| Nitrile | 20 | 30 | 40 | 50 |
| Barium Zinc Stabilizer | 2.5 | 2.5 | 2.5 | 2.5 |
| Epoxidized soybean oil | 4 | 4 | 4 | 4 |
| Running Total (phr) | 191.5 | 201.5 | 211.5 | 221.5 |

TABLE 5

| | Ex. A | Ex. B | Ex. C | Ex. D | Ex. E | Ex. F | Ex. G | Ex. H |
|---|---|---|---|---|---|---|---|---|
| Tensile | 18.5 | 17.9 | 16.6 | 16.2 | 16.7 | 13.5 | 12.3 | 12.9 |
| (MPa) | | | | | | | | |
| Elongation | 341 | 342 | 334 | 344 | 330 | 319 | 307 | 322 |
| (%) | | | | | | | | |
| 100% | 9.4 | 8.4 | 7.3 | 6.8 | 8.1 | 6.3 | 5.9 | 5.9 |
| Modulus | | | | | | | | |
| Hardness | 82 | 80 | 85 | 78 | 84 | 76 | 76 | 78 |
| Shore A | | | | | | | | |
| CE-10 | +10% | +10% | +9% | +6% | +13% | +14% | +17% | +19% |
| Vol. Change | | | | | | | | |
| (%) | | | | | | | | |

The test data in Table 5 shows that increasing the amount of the non-leaching plasticizer reduces the volume change when exposed to fuel; however, increasing amounts of the non-leaching plasticizer also appear to reduce mechanical properties. Although the entire range of 20 phr to 50 phr of the non-leaching plasticizer is suitable for many fuel applications, in some embodiments, particularly for industrial hose, and more particularly for hose product that is extruded, it may be beneficial to include the non-leaching plasticizer in lesser amounts, such as a total amount from 20 phr to 40 phr, or more particularly from 20 phr to 30 phr to improve non-leaching functionality while maintaining strength. It also is envisioned that lower amounts of non-leaching plasticizer, such as 10 phr or 15 phr (including sub-values with the above-noted ranges) also could be suitable in some applications, and is within the scope of the present disclosure; however, 20 phr as a lower bound is found to provide a good tradeoff between dimensional stability in fuel and mechanical strength.

As described above, it also may be beneficial to include a blend of lower molecular weight and higher molecular weight PVC to the compound, as shown in Ex. 1, to further improve the mechanical properties when used in conjunction with the non-leaching plasticizer.

An exemplary thermoplastic PVC compound having the non-leaching plasticizer and material properties suitable for a hose, particularly as an extruded material for a hose, may have one or more properties of: (i) tensile strength according to ASTM D412 in a range from about 5 MPa to about 25 MPa, more particularly from about 10 MPa to about 20 MPa, to provide burst resistance, durability and coupling retention; (ii) elongation according to ASTM D412 of less than 400%; (iii) hardness according to ASTM D2240 in a range from about 50 Shore A to about 90 Shore A, more particularly from about 60 Shore A to about 80 Shore A, to provide flexibility, flex fatigue, and coupling retention. In addition, as noted above, the exemplary thermoplastic PVC compound suitable for a fuel hose, in particular as a drop hose, may have a total volume change in a range from −10% to +25% when soaked in CE-10 fuel for four total consecutive weeks, with drying at ambient temperature (~25 °C) for 24 hours between sequential one week soaks; and/or have a total volume change in a range from −10% to +40% when soaked in B-20 fuel for four total consecutive weeks, with drying at ambient temperature (~25 °C) for 24 hours between sequential one week soaks.

Also as shown in the test data, it was found that including nitrile into the PVC composition caused additional dimensional change during fuel soak testing, and reduced mechanical properties, and thus the exemplary PVC compound may be devoid of nitrile; although it is understood that some compounds within the scope of the present disclosure could include nitrile in the amounts shown above.

In view of the foregoing, an aspect of the present disclosure provides an exemplary thermoplastic PVC compound having a non-leaching plasticizer including ethylene copolymer and butyl acrylate, and has material properties suitable for use in a hose or the like.

Another aspect of the present disclosure provides a thermoplastic material including: polyvinylchloride in a total amount from 80 phr to 100 phr; a non-leaching plasticizer in a total amount from 20 phr to 50 phr, the non-leaching plasticizer having ethylene copolymer and butyl acrylate; at least one additional plasticizer in a total amount from 20 phr to 60 phr; and at least one stabilizer in a total amount from 2 phr to 25 phr.

According to another aspect, a hose includes an inner tube (102), a reinforcement layer (104) disposed outwardly from the inner tube (102), and a cover layer (106) disposed outwardly from the reinforcement layer (104), in which the inner tube (102) comprises a thermoplastic material including polyvinyl chloride (PVC) and a non-leaching plasticizer comprising ethylene copolymer and butyl acrylate.

Exemplary embodiment(s) may include one or more of the following additional features combined with any of the foregoing aspects, in which one or more of these additional features may be combined separately or in any suitable combination with each other.

In exemplary embodiment(s), the non-leaching plasticizer is present in the thermoplastic material in a total amount from 20 phr to 60 phr.

In exemplary embodiment(s), the non-leaching plasticizer is present in the thermoplastic material in a total amount from 20 phr to 40 phr.

In exemplary embodiment(s), the non-leaching plasticizer is present in the thermoplastic material in a total amount from 20 phr to 30 phr,

In exemplary embodiment(s), the ethylene copolymer is present in the thermoplastic material in a total amount from 8 phr to 40 phr, such as from 10 phr to 30 phr.

In exemplary embodiment(s), the butyl acrylate is present in the thermoplastic material in a total amount from 4 phr to 30 phr, such as from 5 phr to 15 phr.

In exemplary embodiment(s), the non-leaching plasticizer is a terpolymer comprising the ethylene copolymer, the butyl acrylate, and a functional group, and the non-leaching plasticizer is coordination bound to a polymer chain of the PVC.

In exemplary embodiment(s), the non-leaching plasticizer includes one or more such polymers having ethylene copolymer and butyl acrylate, more particularly in which such non-leaching plasticizer serves as a non-leaching agent that improves volume swell of the compound in at least CE-10 fuel as compared against a same material without the non-leaching plasticizer.

In exemplary embodiment(s), the PVC has a K-value in a range from K73 to K80, more particularly, wherein the PVC is present in the thermoplastic material in a total amount from 80 phr to 100 phr.

In exemplary embodiment(s), the PVC includes a blend of a first PVC resin and a second PVC resin, the first PVC resin having a lower molecular weight than the second PVC resin.

In exemplary embodiment(s), the first PVC resin is present in the thermoplastic material in a total amount from 20 phr to 60 phr.

In exemplary embodiment(s), the second PVC resin is present in the thermoplastic material in a total amount from 20 phr to 60 phr.

In exemplary embodiment(s), the first PVC resin has a K-value in a range from K65 to K75.

In exemplary embodiment(s), the second PVC resin has a K-value in a range from K76 to K85.

In exemplary embodiment(s), a total plasticizer content of the thermoplastic material includes the non-leaching plasticizer and the second plasticizer, and the total plasticizer content is in a range from 40 phr to 95 phr, more particularly from 50 phr to 70 phr.

In exemplary embodiment(s), a proportion of the non-leaching plasticizer in the total plasticizer content is in a range from 25% to 50%, more particularly 25% to 40%.

In exemplary embodiment(s), the second plasticizer is a carboxylic acid ester, more particularly a trimellitate plasticizer, more particularly trioctyl trimellitate.

In exemplary embodiment(s), the thermoplastic material further comprises one or more stabilizers in a total amount from 5 phr to 25 phr, more particularly from 5 phr to 15 phr.

In exemplary embodiment(s), the one or more stabilizers include: a carboxylate, more particularly barium zinc, in particular in a total amount from 1.5 phr to 3 phr.

In exemplary embodiment(s), the one or more stabilizers include: an epoxidized natural oil, more particularly epoxidized soybean oil.

In exemplary embodiment(s), the epoxidized natural oil is present in a total amount from 3 phr to 20 phr, more particularly in a total amount from 3 phr to 10 phr.

In exemplary embodiment(s), the thermoplastic material has one or more properties of: (i) tensile strength according to ASTM D412 in a range from about 5 MPa to about 25 MPa, more particularly from about 10 MPa to about 20 MPa; (ii) elongation according to ASTM D412 of less than 400%; (iii) hardness according to ASTM D2240 in a range from about 50 Shore A to about 90 Shore A, more particularly from about 60 Shore A to about 80 Shore A; (iv) a total volume change in a range from −10% to +25% when soaked in CE-10 fuel for four total consecutive weeks, with drying at ambient temperature (~25 °C) for 24 hours between sequential one week soaks; and/or (v) a total volume change in a range from −10% to +40% when soaked in B-20 fuel for four total consecutive weeks, with drying at ambient temperature (~25 °C) for 24 hours between sequential one week soaks.

In exemplary embodiments(s), the material may be suitable for use in a hose or articles other than fuel hose, for example, in other fluid hoses where anti-leaching is an attribute, such as oil, solvent or water hoses; or in articles that are exposed to such chemicals.

In exemplary embodiments(s), the hose is configured as a fuel drop hose, in which: the inner tube is formed from the thermoplastic material; the reinforcement layer includes strands of polyethylene fiber; and the outer cover layer is formed from a second thermoplastic PVC that is different from the thermoplastic material of the inner tube.

According to another aspect, a fuel system includes: a vehicle storage tank, a second storage tank, and the hose according to any of the foregoing, having a first connector connecting the hose to the vehicle storage tank and a second connector connecting the hose to the second storage tank.

According to another aspect, a method of using a fuel drop hose, includes: providing the hose according to any of the foregoing as the fuel drop hose; and passing fuel through the internal passage of the fuel drop hose.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. Thus, while a particular feature may have been described with respect to only one or more of several embodiments, such feature may be combined with one or more other features of the other embodiments, separately or in any combination. The same may also be varied in many ways. Such variations are not to be regarded as a departure from the disclosure, and all such modifications are intended to be included within the scope of the disclosure. as may be desired and advantageous for any given or particular application.

Any background information contained in this disclosure is to facilitate a better understanding of the various aspects described herein. It should be understood that any such background statements are to be read in this light, and not as admissions of prior art. Likewise, the description and examples are presented herein solely for the purpose of illustrating the various embodiments of the disclosure and should not be construed as a limitation to the scope and applicability of the disclosure.

The phrase “and/or” as used in this disclosure should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The word “or” as used in this disclosure should be understood as being inclusive and not exclusive. For example, when separating items in a list, “or” or “and/or” shall be interpreted as being inclusive, i.e., the inclusion of at least one, but also including more than one, of a number or list of elements, and, optionally, additional unlisted items. For example, a condition A or B is satisfied by anyone of the following: A is true (or present) and B is false (or not present), A is false (or not present) and B is true (or present), and both A and B are true (or present). Only terms clearly indicating exclusivity should be interpreted as indicating exclusive alternatives (i.e. “one or the other but not both”), such as “either,” “only one of,” or “exactly one of.” In other words, such terms of exclusivity refer to the inclusion of exactly one element of a number or list of elements.

Any references to “one embodiment” or “an embodiment” as used herein is understood to mean that a particular element, feature, structure, or characteristic described in connection with the embodiment is included in at least one embodiment. The appearances of the phrase “in one embodiment” in various places in the specification are not necessarily referring to the same embodiment.

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The word “exemplary” is used herein to mean “serving as an example or illustration.” Any aspect or design described herein as “exemplary” is not necessarily to be construed as preferred or advantageous over other aspects or designs. Likewise, the phrases “particularly,” “preferably,” or the like as used in this disclosure may refer to an element or value that provides preferable advantage(s) in some embodiment(s), however is not intended to limit the scope of the disclosure to those “particular” or “preferable” features.

Transitional language such as “including,” “comprising,” “having.” “containing,” “involving,” or variations thereof, is intended to be broad and encompass the subject matter listed thereafter, equivalents, and additional subject matter not recited, i.e., to be open-ended and meaning including but not limited to.

It is to be understood that terms such as “top,” “bottom,” “upper,” “lower,” “left,” “right,” “front,” “rear,” “forward,” “rearward,” or the like may refer to an arbitrary frame of reference, rather than to the ordinary gravitational frame of reference.

It is to be understood that all values, ranges, ratios or the like as described in this disclosure may be combined in any manner. In addition, it is to be understood that a concentration or amount or value range listed in this disclosure is intended to include any and every concentration or amount or value within the range, including the end points, as if each value within the range has been expressly stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor(s) appreciate and understand that any and all data points within the range are to be considered to have been specified, and that inventor(s) had possession of the entire range and all points within the range.

In addition, each numerical value used in this disclosure should be read once as modified by the term “about” (unless already expressly so modified), and then read again as not so modified unless otherwise indicated in context. The term “about” as used herein refers to any value which lies within the range defined by a variation of up to ±10% of the stated value, for example, ±10%, ±9%, ±8%, ±7%, ±6%, ±5%, ±4%, ±3%, #2%, ±1%, ±0.01%, or ±0.0% of the stated value, as well as values intervening such stated values. When the term “about” is used in describing a value or an end-point of a range, the disclosure should be understood to include the specific value or end-point referred to.

The term “consisting essentially of” in relation to a composition is to indicate that substantially (e.g., greater than 95 weight % or greater than 99 weight %) of the component(s) present in the composition is the component(s) recited. Therefore, this term does not exclude the presence of minor additives or impurities as would be understood by those having ordinary skill in the art.

Although the invention has been shown and described with respect to a certain embodiment or embodiments, it is apparent that equivalent alterations and modifications will occur to those having ordinary skill in the art upon the reading and understanding this disclosure, and such modifications are intended to be included within the scope of this disclosure as defined in the claims. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure.

### LIST OF REFERENCE NUMERALS (PART OF THE SPECIFICATION)

100 Hose
102 Inner tube
104 Reinforcing layer
106 Cover layer
200 Hose
208 Intermediate layer, ply reinforcement, bonding layer, backing, or barrier layer
300 Hose
310 Friction layer or filler layer
312 Second reinforcing layer
400 Hose
500 Hose
502 Friction layer or filler layer
504 Friction layer or filler layer
600 Hose
700 Hose
720 Hose end
722 Hose end
724 Fluid connector
726 Fluid connector
730 Reinforcement strands

1. A hose comprising:
an inner tube forming an internal passage,
a reinforcement layer disposed outwardly from the inner tube, and
a cover layer disposed outwardly from the reinforcement layer,
wherein the inner tube comprises a thermoplastic material including polyvinyl chloride (PVC) and a non-leaching plasticizer comprising ethylene copolymer and butyl acrylate.

2. The hose according to claim 1,
wherein the non-leaching plasticizer is present in the thermoplastic material in a total amount from 20 phr to 60 phr.

3. The hose according to claim 2,
wherein the non-leaching plasticizer is present in the thermoplastic material in a total amount from 20 phr to 40 phr, more particularly from 20 phr to 30 phr.

4. The hose according to claim 2,
wherein the ethylene copolymer is present in the thermoplastic material in a total amount from 8 phr to 40 phr, more particularly from 10 phr to 30 phr; and
wherein the butyl acrylate is present in the thermoplastic material in a total amount from 4 phr to 30 phr, more particularly from 5 phr to 15 phr.

5. The hose according to claim 1,
wherein the non-leaching plasticizer is a terpolymer comprising the ethylene copolymer, the butyl acrylate, and a functional group, and the non-leaching plasticizer is coordination bound to a polymer chain of the PVC.

6. The hose according to claim 1,
wherein the PVC has a K-value in a range from K73 to K80,
particularly, wherein the PVC is present in the thermoplastic material in a total amount from 80 phr to 100 phr.

7. The hose according to claim 1,
wherein the PVC includes a blend of a first PVC resin and a second PVC resin, the first PVC resin having a lower molecular weight than the second PVC resin;
more particularly,
wherein the first PVC resin is present in the thermoplastic material in a total amount from 20 phr to 60 phr, and
wherein the second PVC resin is present in the thermoplastic material in a total amount from 20 phr to 60 phr.

8. The hose according to claim 7,
wherein the first PVC resin has a K-value in a range from K65 to K75, and
wherein the second PVC resin has a K-value in a range from K76 to K85.

9. The hose according to claim 1,
wherein the thermoplastic material includes a second plasticizer in a total amount from 20 phr to 60 phr, more particularly from 30 phr to 50 phr.

10. The hose according to claim 9,
wherein a total plasticizer content of the thermoplastic material includes the non-leaching plasticizer and the second plasticizer, and the total plasticizer content is in a range from 40 phr to 95 phr, more particularly from 50 phr to 70 phr, and
wherein a proportion of the non-leaching plasticizer in the total plasticizer content is in a range from 25% to 50%, more particularly 25% to 40%.

11. The hose according to claim 9,
wherein the second plasticizer is a carboxylic acid ester, more particularly a trimellitate plasticizer, more particularly trioctyl trimellitate.

12. The hose according to claim 1,
wherein the thermoplastic material further comprises one or more stabilizers in a total amount from 5 phr to 25 phr, more particularly from 5 phr to 15 phr.

13. The hose according to claim 12, wherein the one or more stabilizers include:
a carboxylate, more particularly barium zinc, in particular in a total amount from 1.5 phr to 3 phr, and
an epoxidized natural oil, more particularly epoxidized soybean oil, in particular in a total amount from 3 phr to 20 phr, more particularly in a total amount from 3 phr to 10 phr.

14. The hose according to claim 1,
wherein the thermoplastic material of the inner tube has one or more properties of:
(i) tensile strength according to ASTM D412 in a range from about 5 MPa to about 25 MPa, more particularly from about 10 MPa to about 20 MPa;
(ii) elongation according to ASTM D412 of less than 400%;
(iii) hardness according to ASTM D2240 in a range from about 50 Shore A to about 90 Shore A, more particularly from about 60 Shore A to about 80 Shore A;
(iv) a total volume change in a range from −10% to +25% when soaked in CE-10 fuel for four total consecutive weeks, with drying at ambient temperature (~25 °C) for 24 hours between sequential one week soaks; and/or
(v) a total volume change in a range from −10% to +40% when soaked in B-20 fuel for four total consecutive weeks, with drying at ambient temperature (~25 °C) for 24 hours between sequential one week soaks.

15. The hose according to claim 1, or any other preceding claim,
wherein the hose is configured as a fuel drop hose, in which:
the inner tube is formed from the thermoplastic material;
the reinforcement layer includes strands of polyethylene fiber; and
the outer cover layer is formed from a second thermoplastic PVC that is different from the thermoplastic material of the inner tube.

16. A fuel system comprising,
a vehicle storage tank, a second storage tank, and the hose according to claim 1, having a first connector connecting the hose to the vehicle storage tank and a second connector connecting the hose to the second storage tank.

17. A method of using a fuel drop hose, comprising:
providing the hose according to claim 1, as the fuel drop hose; and
passing fuel through the internal passage of the fuel drop hose.

18. A thermoplastic material, comprising:
polyvinylchloride in a total amount from 80 phr to 100 phr;
a non-leaching plasticizer in a total amount from 20 phr to 50 phr, the non-leaching plasticizer having ethylene copolymer and butyl acrylate;
at least one additional plasticizer in a total amount from 20 phr to 60 phr; and
at least one stabilizer in a total amount from 2 phr to 25 phr.

19. The thermoplastic material according to claim 18,
wherein the non-leaching plasticizer is present in the thermoplastic material in a total amount from 20 phr to 40 phr, more particularly from 20 phr to 30 phr,
in particular, wherein the ethylene copolymer is present in the thermoplastic material in a total amount from 8 phr to 40 phr, more particularly from 10 phr to 30 phr; and
in particular, wherein the butyl acrylate is present in the thermoplastic material in a total amount from 4 phr to 30 phr, more particularly from 5 phr to 15 phr.

20. The thermoplastic material according to claim 18,
wherein the PVC includes a blend of a first PVC resin and a second PVC resin, the first PVC resin having a lower molecular weight than the second PVC resin;
wherein the first PVC resin is present in the thermoplastic material in a total amount from 20 phr to 60 phr, and wherein the second PVC resin is present in the thermoplastic material in a total amount from 20 phr to 60 phr;
in particular, wherein the first PVC resin has a K-value in a range from K65 to K75, and the second PVC resin has a K-value in a range from K76 to K85.

21. The thermoplastic material according to claim 18, wherein a total plasticizer content of the thermoplastic material includes the non-leaching plasticizer and the second plasticizer, and the total plasticizer content is in a range from 40 phr to 95 phr, more particularly from 50 phr to 70 phr, and
wherein a proportion of the non-leaching plasticizer in the total plasticizer content is in a range from 25% to 50%, more particularly 25% to 40%;
in particular, wherein the second plasticizer is a carboxylic acid ester, more particularly a trimellitate plasticizer, more particularly trioctyl trimellitate.

22. The thermoplastic material according to claim 18, wherein the one or more stabilizers include:
a carboxylate, more particularly barium zinc, in particular in a total amount from 1.5 phr to 3 phr, and
an epoxidized natural oil, more particularly epoxidized soybean oil, in particular in a total amount from 3 phr to 20 phr, more particularly in a total amount from 3 phr to 10 phr.

23. The thermoplastic material according to claim 18, having one or more properties of:
(i) tensile strength according to ASTM D412 in a range from about 5 MPa to about 25 MPa, more particularly from about 10 MPa to about 20 MPa;
(ii) elongation according to ASTM D412 of less than 400%;
(iii) hardness according to ASTM D2240 in a range from about 50 Shore A to about 90 Shore A, more particularly from about 60 Shore A to about 80 Shore A;
(iv) a total volume change in a range from −10% to +25% when soaked in CE-10 fuel for four total consecutive weeks, with drying at ambient temperature (~25 °C) for 24 hours between sequential one week soaks; and/or
(v) a total volume change in a range from −10% to +40% when soaked in B-20 fuel for four total consecutive weeks, with drying at ambient temperature (~25 °C) for 24 hours between sequential one week soaks.

24. A thermoplastic PVC compound comprising a non-leaching plasticizer including ethylene copolymer and butyl acrylate, and having one or more properties of:
(i) tensile according to ASTM D412 strength in a range from about 5 MPa to about 25 MPa, more particularly from about 10 MPa to about 20 MPa;
(ii) elongation according to ASTM D412 of less than 400%;
(iii) hardness according to ASTM D2240 in a range from about 50 Shore A to about 90 Shore A, more particularly from about 60 Shore A to about 80 Shore A;
(iv) a total volume change in a range from −10% to +25% when soaked in CE-10 fuel for four total consecutive weeks, with drying at ambient temperature (~25 °C) for 24 hours between sequential one week soaks; and/or
(v) a total volume change in a range from −10% to +40% when soaked in B-20 fuel for four total consecutive weeks, with drying at ambient temperature (~25 °C) for 24 hours between sequential one week soaks.
